(19) United States
(12) Patent Application Publication
(10) Pub. No.: US 2005/0012329 A1
(43) Pub. Date: Jan. 20, 2005

(54) Swivel fitting

(76) Inventor: Ronald G. Brown, Pittsburg, KS (US)

Correspondence Address: John C. McMahon, 4700 Belleview Suite 410, P.O. Box 30069, Kansas City, KS, 64112, US

(21) Appl. No.: 10/623,233

(22) Filed: Jul. 18, 2003

(51) Int. Cl. F16L 27/00; F16L 37/52

(52) U.S. Cl. 285/272; 285/147.1

(57) ABSTRACT

A swivel fitting includes a body with a proximal contact section having a frusto-spherical contact surface and a distal stem section extending therefrom. A body bore extends through the sections and is open at body proximal and distal ends of the body. The contact section is multi-axially pivotably received in a housing assembly including an annular outer sleeve, which encircles an annular seal forming a frusto-spherical socket. The body contact surface slidably and sealingly engages the socket. Applications for the swivel pipe fitting including various fluid conveying systems and other applications for articulated components. Various connecting techniques can be used for joining the fitting to in-line components, and the fitting parts can comprise various materials.

### BACKGROUND OF THE INVENTION

1. Field of the Invention

The present invention relates generally to swivel fittings, and in particular to a swivel fitting system for multi-axis articulation of connected pipes and other components.

2. Discussion of the Related Art

Various fittings and connecting devices have previously been developed for joining fluid-conveying pipes and other components. Common connecting device examples include elbows, T-connectors, unions, etc. The components joined by same are also relatively diverse. Fluid-handling components for receiving, using and transferring various fluids, including both liquid and gaseous phase fluids, represent a large class of applications for fluid-conveying fittings and connectors.

A commonly encountered problem relates to joining components which are misaligned, or which move relative to each other. For example, many plumbing fittings are connected to pipes for fluid supply or discharge. Although conventional connectors can sometimes be combined to connect misaligned components, it is generally preferable to minimize the use of extra elbows and other fittings when making such connections. Moreover, conventional connectors are often rigid with predefined geometries, which limit their adaptability to handle a wide range of fluid-handling component misalignments.

Other types of fluid-handling component systems are designed for dynamic applications where the interconnected components must accommodate relative movement. For example, mobile equipment and subsurface, terrestrial fluid systems, such as underground utilities and irrigation, are often designed to accommodate relative movement among components. Prior art solutions include flexible connecting members fabricated from various materials adapted for flexure in response to relative movement among the connected components. Other devices have been designed to allow components to swivel or rotate with respect to one or more axes of movement. By combining various prior art connecting devices, multiple component misalignment and dynamic loading conditions can often be handled.

However, a disadvantage associated with many prior art systems relates to the necessity to combine multiple connectors, and rigidity in the resulting systems. Heretofore there have not been available a swivel fitting and multi-axial articulated coupling applications for same with the advantages and features of the present invention.

### BRIEF DESCRIPTION OF THE INVENTION

In the practice of one aspect of the present invention, a multi-axially pivotable swivel fitting is provided for connecting fluid components, which can comprise pipes or other components. The fitting comprises a body with a frusto-spherical contact section pivotably received in a socket formed by an annular gasket of a housing assembly. The resulting ball-and-socket assembly can swivel with respect to multiple axes. Various applications are suitable for the fitting, such as different plumbing and fluid-handling systems. The fitting sections can be connected to other components using a variety of mechanical, adhesive and other joining techniques.

### BRIEF DESCRIPTION OF THE DRAWINGS

The drawings constitute a part of this specification and include exemplary embodiments of the present invention and illustrate various objects and features thereof.

FIG. 1 is a perspective view of a swivel fitting embodying the present invention.

FIG. 2 is a longitudinal, cross-sectional view thereof, shown connecting first and second pipes.

FIG. 3 is a longitudinal, cross-sectional view thereof, showing the fitting articulated between angled positions thereof.

FIG. 4 is a longitudinal, cross-sectional view of an application of a pair of fittings.

FIG. 5 is a vertical, cross-sectional view of an in-ground sprinkler system application.

FIG. 6 is a vertical, cross-sectional view of a sanitary sewer system application.

FIG. 7 is a cross-sectional view of external threads for connecting the fitting.

FIG. 8 is a cross-sectional view of internal threads for connecting the fitting.

FIG. 9 is a cross-sectional view of external, annular barbs for connecting the fitting.

FIG. 10 is a cross-sectional view of internal, annular barbs for connecting the fitting.

FIG. 11 is a cross-sectional view of a solvent adhesive connection for the fitting.

FIG. 12 is a cross-sectional view of an O-ring gasket for connecting the fitting.

FIG. 13 is a cross-sectional view of a compression fitting assembly for connecting the fitting.

FIG. 14 is a cross-sectional view of a welded connection for the fitting.

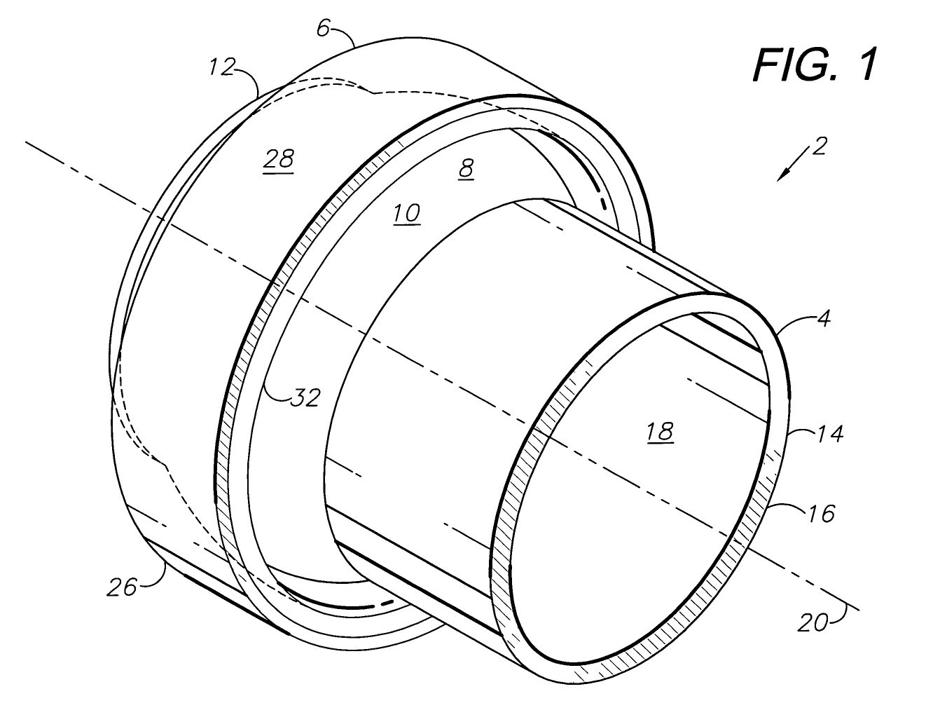

### DETAILED DESCRIPTION OF THE INVENTION

As required, detailed embodiments and/or aspects of the present invention are disclosed herein; however, it is to be understood that the disclosed embodiments/aspects are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Referring to the drawings in more detail, the reference numeral 2 generally designates a swivel pipe fitting embodying an aspect of the present invention. The fitting 2 generally includes a body 4 multi-axially pivotably mounted in a housing 6. The body 4 includes a proximal, contact section 8 with a frusto-spherical contact surface 10 and a rimmed proximal body end 12. The body 4 also includes a distal stem section 14 with a generally cylindrical configuration and a distal body end 16. A body bore 18 extends coaxially with a body axis 20 between and open at the body ends 12, 16. A housing assembly 24 includes an annular sleeve 26 with a generally cylindrical outer surface 28 and a sleeve receiver 30 fixedly receiving an annular seal 32 including a frusto-spherical seal receiver or socket 34, which is defined by a seal contact surface 36.

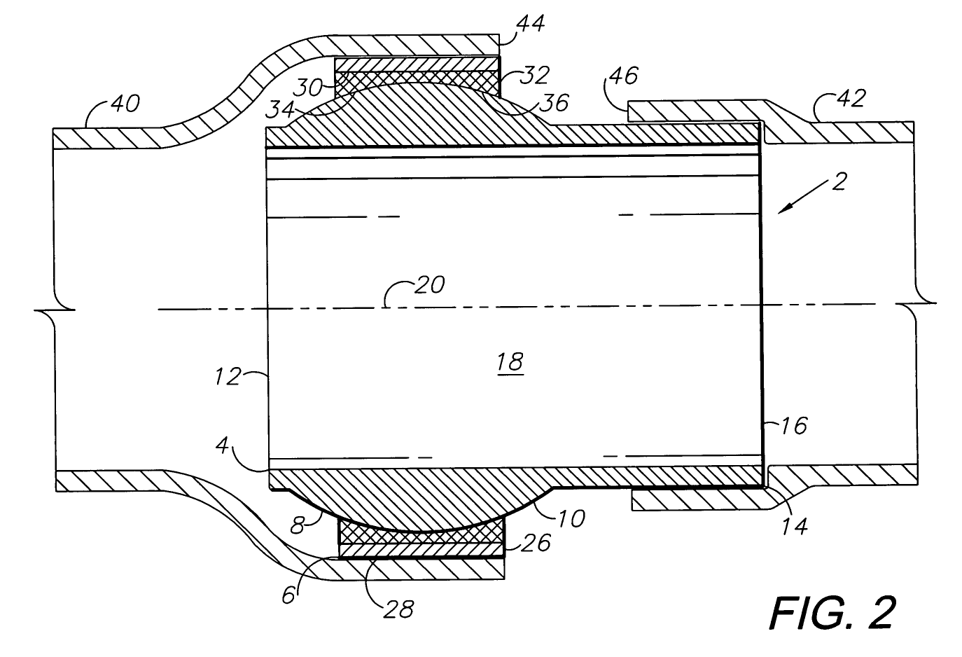

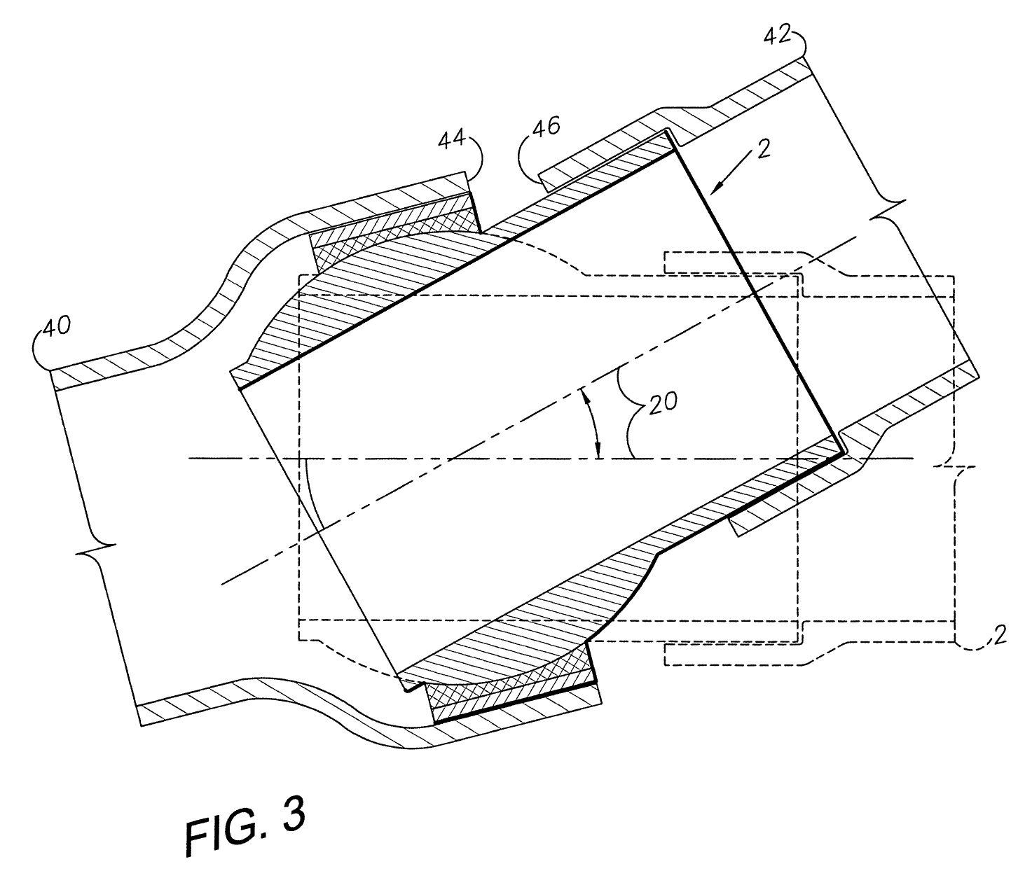

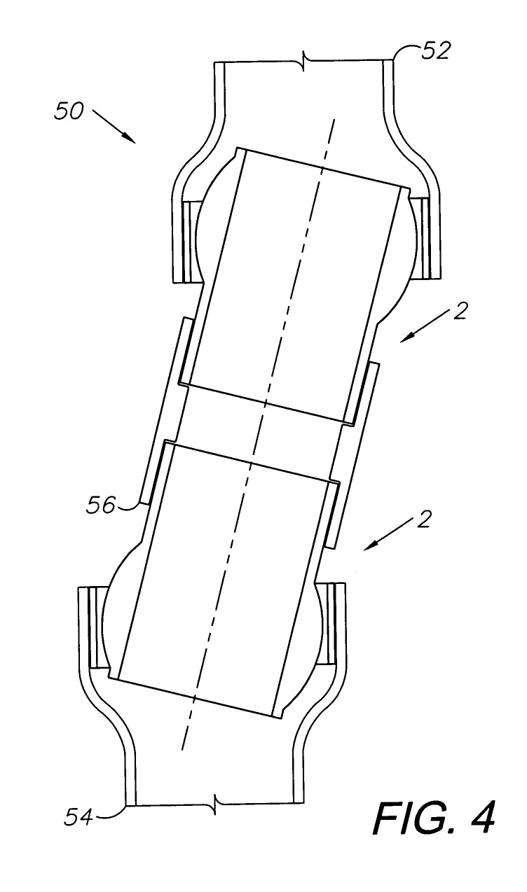

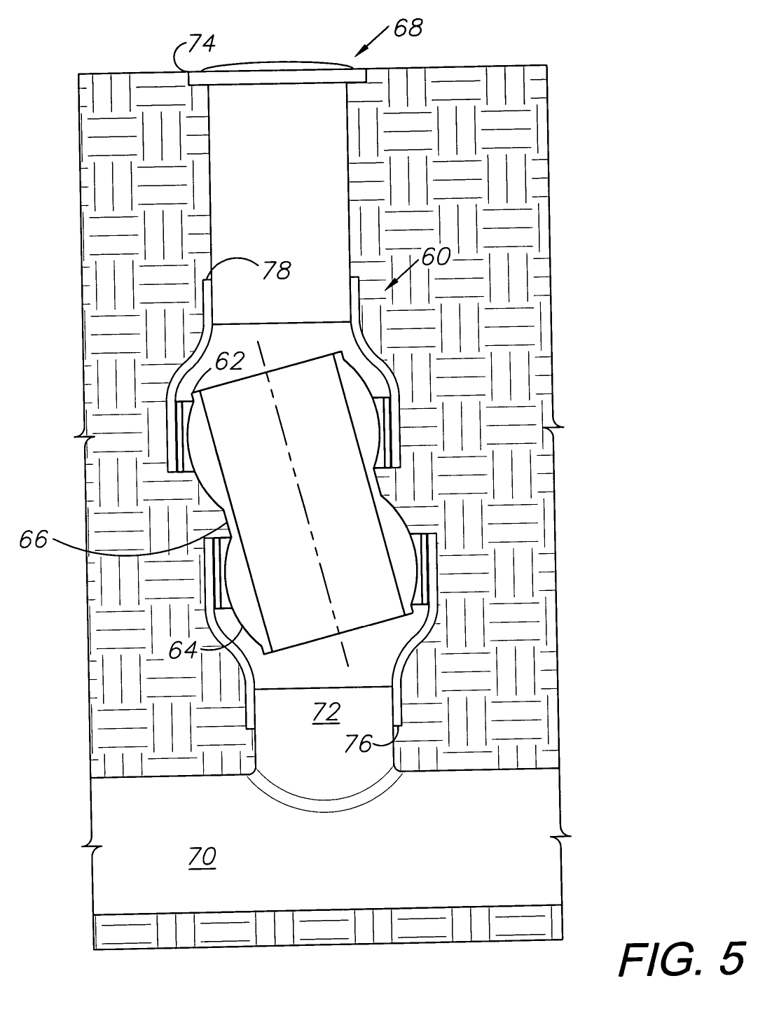

As shown in FIG. 2, the fitting 2 is adapted for connecting first and second fluid components 40, 42, such as the bell-end pipes as shown, with respective open ends 44, 46, which telescopically receive the stem section 14 and the sleeve 26. With the pipes 40, 42 thus joined, the multi-axially pivotable function of the fitting 2 enables practically infinite variations on pipe alignment and displacement. For example, FIG. 3 shows the stem section 14 in a first extreme position in solid lines and in another extreme position in dashed lines. FIG. 4 shows a pair of fittings 2 in an offsetting pipe connection system 50 with first and second bell-end pipes 52, 54 having generally parallel but displaced axes. The fittings 2 are joined at their stem sections 14 by a coupling 56. FIG. 5 shows another aspect of the invention comprising a double fitting 60 adapted for applications similar to the parallel, offset pipes 52, 54 shown in FIG. 4 and including a double contact section 62 with a pair of frusto-spherical contact surfaces 64 joined by a cylindrical neck 66. The double fitting 60 includes a pair of housing assemblies 24 as described above, which pivotably receive the contact sections 62.

Without limitation on the generality of useful applications for the fittings 4 and 60, FIG. 5 shows an underground sprinkler system 68 with a water supply line 70 having a T-connector 72 mounting a first adapter 76, which is connected to a respective contact section 8. A pop-up sprinkler head 74 is mounted on a second adapter 78, which is connected to the other contact section 8. The adapters 76, 78 can be various suitable lengths for accommodating different supply pipe depths, displacements, sprinkler heads, etc.

FIG. 6 shows another application or aspect of the invention comprising a sanitary sewer connection system 80 with a main waste line 82, which can be located below grade, below the floor of a structure, etc. A saddle-type T-fitting 84 is mounted on the line 82 for tapping a particular fixture, such as a toilet, into the sanitary sewer system. The saddle fitting 84 mounts the housing assembly 24 of a first fitting 2. An extension 86 connected to a second fitting 4 mounts a floor flange 88.

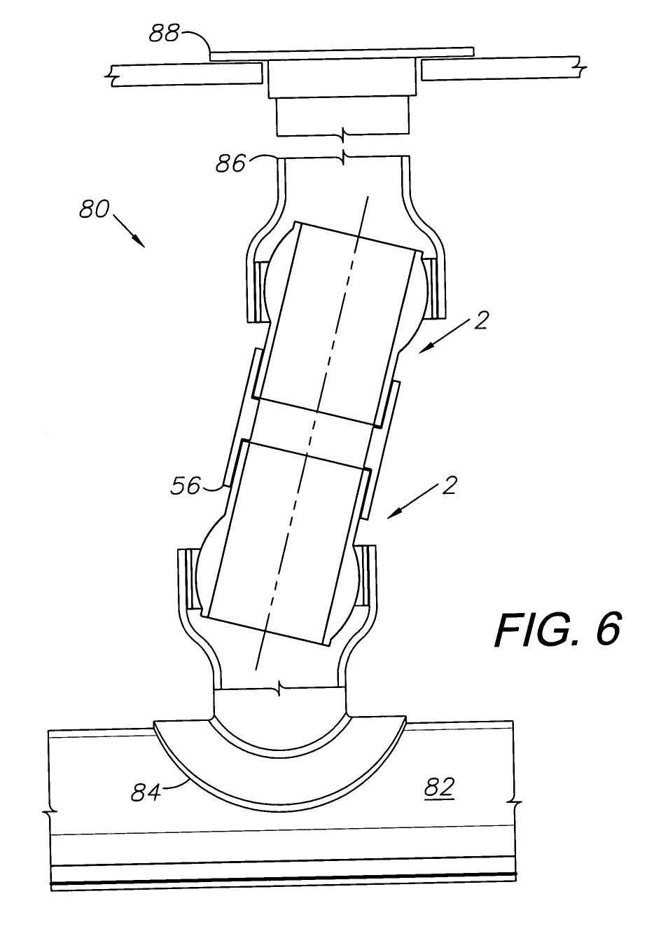

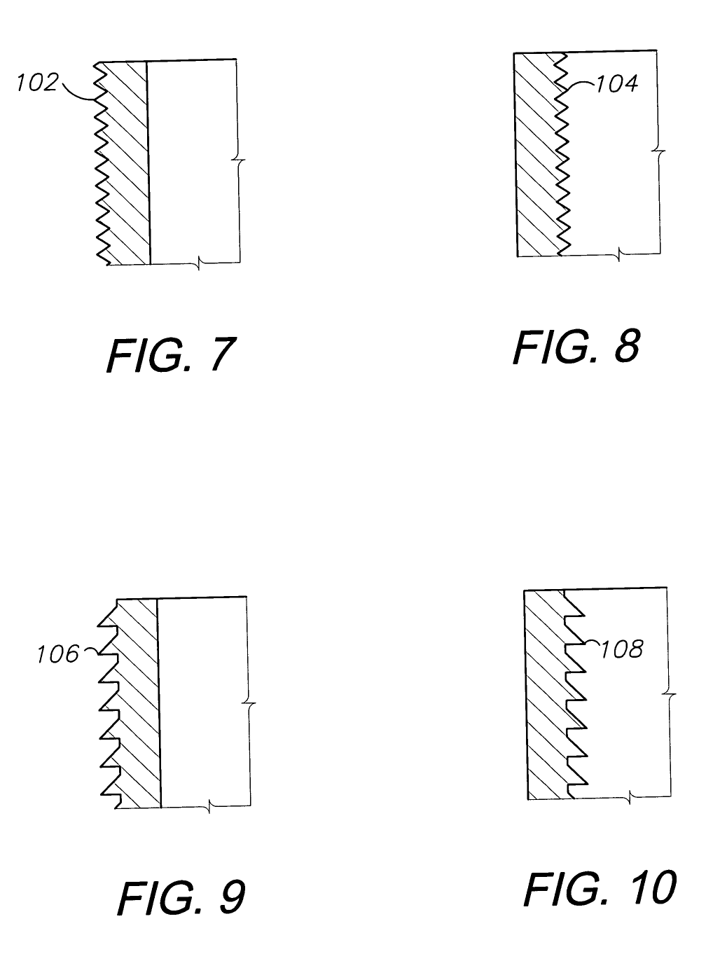

Various means are available and are known to those skilled in the applicable arts for joining the fitting to other in-line components. Without limitation on the generality of useful connecting means, examples are shown in FIGS. 7-14, and are applicable to either or both of the stem section 14 adjacent to the proximal body end 12 and the sleeve 26. In other words, similar or different connectors can be used for connecting the fittings 2, 60 to respective upstream and downstream components.

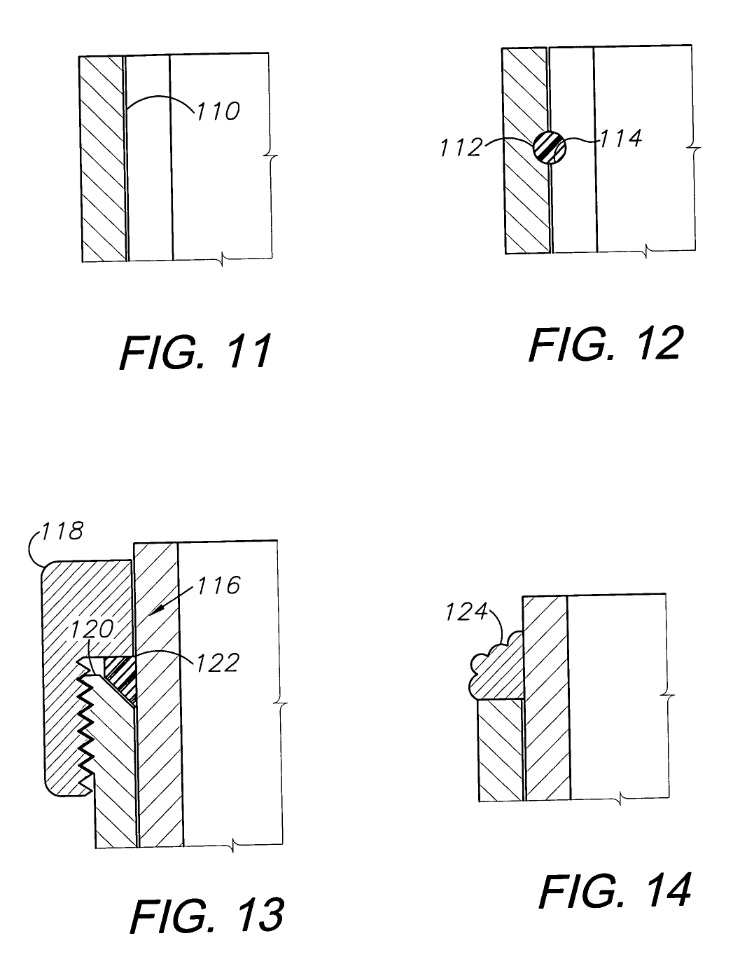

FIGS. 7 and 8 show external and internal threads 102, 104 respectively. FIGS. 9 and 10 show external and internal annular barbs 106, 108 respectively. The barbs 106, 108 are oriented to facilitate forming the coupling by inserting one component into another, but resist pull-out. FIG. 11 shows a solvent adhesive layer 110 between the respective components, such as the stem section 14 or the sleeve 26, and a pipe end 44 or 46. Various suitable adhesives can be used for solvent-welding the components together. FIG. 12 shows a gasket 112, such as an O-ring, captured in respective annular grooves formed in the components. FIG. 13 shows a compression fitting assembly 116 with a nut 118 threadably placed on a male-threaded component end 120 for compressing an annular compression seal ring 122. FIG. 14 shows an annular weldment 124 joining the components. Other suitable connections (not shown) include cam locks, wedge locks, lock rings and snap rings.

The body 4 and the sleeve 26 can comprise various suitable materials, including metal, plastic (e.g., PVC or ABS), glass, fiberglass, rubber, elastomers, clay, concrete, etc. The seal 32 can likewise comprise various suitable materials, such as metal, plastic, elastomers, etc. Dissimilar materials can be used for the components. Moreover, the body stem section 14 and the sleeve 26 are not limited to round configurations, but can the formed as polygons and other geometric shapes. Dissimilar materials and dissimilar sizes of the body and a housing assembly can be employed as necessary for particular applications. Still further, various fluids, such as air and other gasses, can be handled by the fittings 2, 60. Non-fluid conveying applications include furniture, pipe racks and pipe railings. The multi-axially pivotable arrangement of the fitting 4 accommodates misalignment and displacement of various components. The fittings 2, 64 can further accommodate mobile, dynamic applications where components reposition themselves with respect to each other and are accommodated by the fittings 2, 64.

It will be appreciated that while certain exemplary aspects and embodiments of the invention are shown and described herein, numerous other aspects and embodiments are within the scope of the invention, which is not to be limited to the specific examples shown and described.

1. A swivel fitting, which comprises:
a body including a proximal, contact section with a first contact surface and a distal stern section extending form the contact section; said body contact surface extending radially outward and being frusto conical in shape;
said body including proximal and distal ends located at said contact and stem sections respectively;
a body bore extending through said body and open at said ends;
a housing including an outer surface and a receiver including a radially inward second contact surface that is frusto conical and that is sized and shaped to be slidingly but sealably received on said body contact surface; said housing outer surface being cylindrical in shape and adapted so as to be sized and shaped to be received on a cylindrical inner surface of a pipe;
in use said receiver receiving said bodv contact section with said body and receiver contact surfaces in engagement; and
said contact surfaces being slidable with respect to each other whereby said body is pivotably received in said housing.

2. The fitting according to claim 1, which includes:
said stem section having a generally cylindrical configuration;
said body including an axis extending coaxially through said bore;
said housing having an annular configuration; and
said body being multi-axially pivotably received in said housing.

3. The fitting according to claim 2, which includes:
said housing including an annular seal including said receiver contact surface and an annular sleeve receiving said seal.

4. The fitting according to claim 3 wherein said body comprises a material chosen from among: metal, plastic, glass, rubber, elastomer, clay and concrete.

5. The fitting according to claim 3 wherein the housing comprises a material chosen from among: metal, plastic, glass, rubber, elastomer, clay and concrete.

6. The fitting according to claim 3 wherein said seal comprises a material chosen from among: metal, plastic, glass, rubber and elastomer.

7. The fitting according to claim 3 wherein said body and said housing assembly have circular cross-sectional configurations.

8. (Canceled)

9. The fitting according to claim 1 wherein said stem section includes means for connecting same in sealing engagement with an in-line component.

10. The fitting according to claim 9 wherein said stem section connecting means to chosen from among external threads, internal threads, external barbs, internal barbs, adhesive, gasket, compression seal and weldment.

11. The fitting according to claim 1 wherein said housing outer surface includes means for connecting same in sealing engagement with an in-line component.

12. (Canceled)

13. A fluid connection system for connecting first and second fluid components positioned in displaced misalignment or dynamic relationship with respect to each other, which system comprises:
first and second multi-axis swivel fittings connected to said first and second components respectively;
each said fitting including: a body with a proximal contact section having a radially outward extending frusto-spherical contact surface and a distal stem section extending coaxially therefrom; proximal and distal body ends located at said contact and stem sections respectively; a body bore extending between and open at said body ends; and a housing assembly including an annular seal with a radially inward facing frusto conical shaped receiver sized and shaped to form a socket to receive said body frusto-spherical contact surface and an annular sleeve receiving said seal; said sleeve having a cylindrical radially outer surface;
said contact surfaces being in sliding engagement with said body contact sections multi-axially pivotably received in respective said sockets;
a first component connector having a first cylindrical inner surface operably sealably receiving said first fitting sleeve outer surface and fluidically connecting said first component to said first fitting;
an intermediate connector fluidically connecting said first and second fittings;
a second component connector having a second cylindrical inner surface operably sealably receiving said second fitting sleeve outer surface and fluidically connecting said second fitting to said second component; and
said fittings being independently, multi-axially pivotable whereby said system is adapted for universal, adjustable offset alignment of said components.

14. The system according to claim 13, which includes:
said first component connector being connected to said first fitting sleeve;
said intermediate connector being connector to said body distal ends of said first and second fittings; and
said second component connector being connector to said second fitting sleeve.

15. The system according to claim 14, which includes:
said first component connector comprising a bell end mounted on said first component and including an open end having said first cylindrical inner surface and receiving said first fitting sleeve;
said intermediate connector having a tubular configuration with first and second ends receiving said distal body ends of said first and second fittings respectively; and
said second component connector comprising a bell end mounted on said second component and including an open end having said second cylindrical inner surface and receiving said second fitting sleeve.

16. The system according to claim 13, which includes:
said first component connector comprising a bell end mounted on said first component and including an open end receiving said first fitting sleeve;
said intermediate connector comprising a neck with a hollow, tubular configuration and integrally formed with said first and second fitting bodies;
said bores extending continuously through said bodies and said neck; and
said second component connector comprising a bell end mounted on said second component and including an open end receiving said second fitting sleeve.

17. The system according to claim 16, which includes:
said bodies comprising a unitary component with a maximum diameter at said body contact surfaces and a reduced diameter at said neck.

18. The system according to claim 13 wherein each said body distal end includes an annular
lip forming a stop adapted for engaging a respective seal with said fitting in an extreme angular orientation thereof.

19. In combination with a sewer system having a main, subsurface sanitary sewer pipe and multiple inlet fitting adapted for mounting plumbing fixtures, the improvement of a multi-axis swivel connection system for interconnecting the inlet fittings with the pipe and for accommodating misalignment therebetween, which connection system comprises:
first and second multi-axis swivel fittings:
each said fitting including: a body with a proximal contact section having an outward extending frusto-spherical contact surface and a distal stem section extending coaxially therefrom; proximal and distal body ends located at said contact and stem sections respectively; a body bore extending between and open at said body ends; and a housing assembly including a seal having an inward facing frusto conical contact surface sized and shaped to receive said body contact surface so as to form a socket with a frusto-spherical contact surface and an annular sleeve receiving said seal; said housing having an outer cylindrical surface;
said seal contact surfaces being in sliding engagement with respective body contact surfaces with said body contact sections multi-axially pivotably received in respective sockets;
a saddle connector mounted on said pipe and including a bell end having a cylindrical shaped first inner surface sized and shaped to receive said first fitting sleeve, such saddle connector being adapted for transferring discharge from said connection system to said pipe;
an intermediate connector fluidically connecting said stem sections of said first and second fittings;
an upper connector connected to said inlet fitting and including a bell end having a cylindrical shaped second inner surface sized and shaped to receive said second fitting sleeve, said upper connector receiving discharge from said plumbing fixture and transferring same to said connection system; and
said fittings being independently, multi-axially pivotable whereby said system is adapted for universal, adjustable offset alignment of said components.

20. The connection system according to claim 19 wherein said intermediate connector comprises a tubular component with first and second ends receiving said stem sections of said first and second fittings respectively.

21. A pipe and swivel fitting assembly comprising:
a pipe having a bore and a fitting receiving end; said receiving end having a cylindrical inner surface;
a fitting body having an axially extending bore and a radially outward extending frusto conical surface near one end thereof;
a housing sized and shaped to be positioned between said body frusto conical surface and said pipe receiving end cylindrical inner surface;
said housing having a frusto conical surface on the radially inner side thereof sized and shaped to be sealingly but slideably received on said body frusto conical surface; and
said housing having a radially outer cylindrical surface sized and shaped to sealingly mate with said pipe cylindrical inner surface.

22. The assembly according to claim 20 including:
said housing includes a seal on the inner side thereof and an annular sleeve operably positioned between said pipe and said seal.
